(19) United States
(12) Patent Application Publication
(10) Pub. No.: US 2026/0339589 A1
(43) Pub. Date: Oct. 29, 2026

(54) METHOD, APPARATUS, DEVICE, MEDIUM AND PRODUCT FOR DISPLAYING IMAGE

(71) Applicant: Bytedance Technology Ltd., Grand Cayman (KY)

(72) Inventors: Shaoqin Lin, Beijing (CN); Yunpeng Li, Beijing (CN)

(21) Appl. No.: 19/656,451

(22) Filed: Apr. 23, 2026

(30) Foreign Application Priority Data
Apr. 25, 2025 (WO) PCT/SG2025/050277

(51) Int. Cl. G06F 3/14; G06F 3/04845

(52) U.S. Cl. CPC G06F 3/1423; G06F 3/04845

(57) ABSTRACT

Embodiments of the present disclosure relate to a method, an apparatus, a device, a medium, and a product for displaying an image. The method includes determining a plurality of display containers available on a screen for displaying an image, wherein the plurality of display containers have different aspect ratios. The method further includes determining a target display container from the plurality of display containers based on a first aspect ratio of the image to be displayed in the screen, a difference between a second aspect ratio of the target display container and the first aspect ratio being less than a threshold value. The method further includes displaying the image in the target display container based on a cropping proportion of the image in the target display container.

### CROSS-REFERENCE TO RELATED APPLICATION(S)

This application claims priority to International Patent Application No. PCT/SG2025/050277, filed on Apr. 25, 2025, the disclosure of which is incorporated herein by reference in its entirety.

### FIELD

Embodiments of the present disclosure generally relate to the field of computer vision and multimedia technology, and specifically to a method and an apparatus for displaying an image, a device, a medium and a product.

### BACKGROUND

With the rapid popularization of mobile devices, users raise higher requirements for an excellent presentation effect of diverse content on different devices. In modern application scenarios, the diversity of screen dimensions, aspect ratios, and content formats imposes critical challenges on a display effect. Especially in a content consumption platform centered around short videos and pictures, how to achieve consistent and optimized display effect on various devices has become the focus of concerns in the industry.

As display technology continues to advance, enhancing the flexibility and intelligence degree of adaptation strategies has become as a major research direction in the field of display adaptation. Usually, for users, content can adapt to different screens and maintain an excellent visual effect. This can not only improve readability and aesthetic appeal but also enhance users'immersive experience on various devices.

### SUMMARY

Embodiments of the present disclosure provide a method and an apparatus for displaying an image, a device, a medium, and a product.

According to a first aspect of the present disclosure, there is provided a method for displaying an image. The method includes determining a plurality of display containers available on a screen for displaying an image, the plurality of display containers having different aspect ratios. The method further includes determining a target display container from the plurality of display containers based on a first aspect ratio of the image to be displayed in the screen, a difference between a second aspect ratio of the target display container and the first aspect ratio being less than a threshold value. The method further includes displaying the image in the target display container based on a cropping proportion of the image in the target display container.

According to a second aspect of the present disclosure, there is provided an apparatus for displaying an image. The apparatus includes a display container determination module, configured to determine a plurality of display containers available on a screen for displaying an image, the plurality of display containers having different aspect ratios; a target container matching module, configured to determine a target display container from the plurality of display containers based on a first aspect ratio of the image to be displayed in the screen, a difference between a second aspect ratio of the target display container and the first aspect ratio being less than a threshold value; and an image display adjusting module, configured to display the image in the target display container based on a cropping proportion of the image in the target display container.

In a third aspect of the present disclosure, there is provided an electronic device, including at least one processor; and a storage configured to store at least one program, wherein the at least one program, when executed by the at least one processor, causes the at least one processor to implement the method according to the first aspect of the present disclosure.

In a fourth aspect of the present disclosure, there is provided a computer readable storage medium storing a computer program thereon, wherein the computer program, when executed by a processor, implements the method according to the first aspect of the present disclosure.

In a fifth aspect of the present disclosure, there is provided a computer program product. The computer program product includes a computer program, wherein the computer program, when executed by a processor, implements the method according to the first aspect of the present disclosure.

It should be appreciated that the content described in Summary part is not intended to define essential or important features of embodiments of the present disclosure or to limit the scope of the present disclosure. Other features of the present disclosure will be made apparent by the following description.

### BRIEF DESCRIPTION OF THE DRAWINGS

The above and other objects, features and advantages of the present disclosure will become more apparent by reference to the following detailed description of example embodiments of the present disclosure in conjunction with the accompanying drawings, wherein the same reference numerals usually denote the same parts in the example embodiments of the present disclosure.

FIG. 1 illustrates a schematic diagram of an example environment in which a device and/or a method according to some embodiments of the present disclosure may be implemented;

FIG. 2 illustrates a schematic diagram of an example method for displaying an image according to some embodiments of the present disclosure;

FIG. 3A illustrates a schematic diagram of an example of an image display area according to some embodiments of the present disclosure;

FIG. 3B and FIG. 3C illustrate schematic diagrams of examples of display containers according to some embodiments of the present disclosure;

FIG. 4 illustrates a schematic diagram of an example of a fit adaptation according to some embodiments of the present disclosure;

FIG. 5 illustrates a schematic diagram of an example of a cropping adaptation according to some embodiments of the present disclosure;

FIG. 6 illustrates a schematic diagram of an example of image display according to some embodiments of the present disclosure;

FIG. 7 illustrates a schematic diagram of an example of image display according to some embodiments of the present disclosure;

FIG. 8 illustrates a schematic block diagram of an apparatus for displaying an image according to some embodiments of the present disclosure;

FIG. 9 illustrates a schematic block diagram of an example device adapted for implementing a plurality of embodiments of the present disclosure.

### DETAILED DESCRIPTION OF EMBODIMENTS

It may be appreciated that data (including but not limited to the data itself, acquisition or use of data) involved in the technical solution should comply with requirements in relevant laws and regulations and relevant provisions.

It is to be understood that, before the technical solutions disclosed in the embodiments of the present disclosure are used, a user should be informed of a type, a use range, a use scenario, etc. of personal information involved in the present disclosure and authorization should be obtained from the user in an appropriate manner according to relevant laws and regulations.

For example, when the user's active request is received, prompt information is sent to the user to explicitly prompt the user that the operation requested to be performed will require the acquisition and use of the user's personal information. Accordingly, the user may autonomously decide according to the prompt information whether to provide his personal information to software or hardware, such as an electronic device, an application, a server or a storage medium, which performs the operation of the technical solution of the present disclosure.

As an optional but non-limiting implementation, a manner of sending the prompt information to the user in response to receiving the user's active request may for example be a pop-up window in which the prompt information may be presented in a text. In addition, the pop-up window may also carry a selection control for the user to select “agree” or “disagree” to provide the personal information to the electronic device.

It may be appreciated that the above process of notifying and obtaining the user's authorization is merely illustrative and not intended to limit implementations of the present disclosure, and that other manners satisfying relevant laws and regulations may also be applied to implementations of the present disclosure.

Hereinafter, embodiments of the present disclosure will be described in more detail with reference to the figures. Although some embodiments of the present disclosure are shown in the figures, it is to be understood that the present disclosure may be implemented in various forms and should not be construed as being limited to the embodiments illustrated herein; rather, these embodiments are provided to enable more thorough and complete understanding of the present disclosure. It should be appreciated that the drawings and embodiments of the present disclosure are for illustrative purposes only and are not intended to limit the scope of the present disclosure.

In the description of the embodiments of the present disclosure, the term “include” or like words should be considered as being open-ended, i.e., “include but not limited to”. The term “based on” should be understood as meaning “based at least in part on”. The terms “one embodiment” or “the embodiment” should be understood as “at least one embodiment”. The terms “first”, “second” and the like may refer to different or identical objects unless expressly stated otherwise. Other explicit and implicit definitions may also be included below.

As stated above, with the rapid development of mobile internet, more and more pictures and videos can be acquired. How to better display images of different sizes carrying diverse information on different screens has become a critical issue. Typically, when videos in various sizes are received from a server and output to screens of different sizes, two steps need to be performed: screen adaptation and video adaptation. During the screen adaptation, areas that may display are first determined, and then aspect ratios of the video display area are calculated by combining the areas that may display. An aspect ratio closest to 16:9 is selected from all calculated aspect ratios. Subsequently, during the video adaptation, the video is either cropped or a container is padded with black bars according to a comparison between the aspect ratio of the container and the aspect ratio of the video.

However, at present, such method of selecting a container with the aspect ratio closest to the fixed ratio 16:9 is padding the image or video into a display container. This method will cause the display of part of the image defective, and is not only inflexible but also negatively impacts the user's viewing experience. Additionally, the issue with the video adaptation lies in complex conditions for the existing logical judgement, making it difficult to judge the current state or facilitate further iterations, thereby causing a low displaying efficiency and affecting the user's experience.

For example, when a plurality of servers deliver videos of different dimensions, after the container is fixed to a 16:9 aspect ratio, if the screen's aspect ratio is greater than or equal to 18:9 at this time, it is necessary to compare the video's aspect ratio with the container's aspect ratio. If the video's aspect ratio is less than or equal to 16:10 or greater than or equal to 19:9, a strategy of filing the width and filing black bars on the top and bottom is employed. This single example alone may illustrate the complex logic of video adaptation. On account of the complex conditions for logical judgement, the existing solution makes it difficult to judge the current state or facilitate further iterations.

To this end, embodiments of the present disclosure provide a method for displaying an image. In the method, a computing device determines a plurality of display containers available on a screen for displaying the image, wherein the plurality of display containers have different aspect ratios. Then, the computing device determines a target display container from the plurality of display containers based on a first aspect ratio of the image to be displayed in the screen. A difference between a second aspect ratio of the target display container and the first aspect ratio determined at this time is smaller than a threshold value. Next, the computing device further displays the image in the target display container according to a cropping proportion of the image in the target display container. By this method, the logic of video adaptation is simplified, and images in different sizes are displayed on different display screens with a better display effect, so that the image seen by the user is beautiful and the details of the image are not affected, the user's experience is improved.

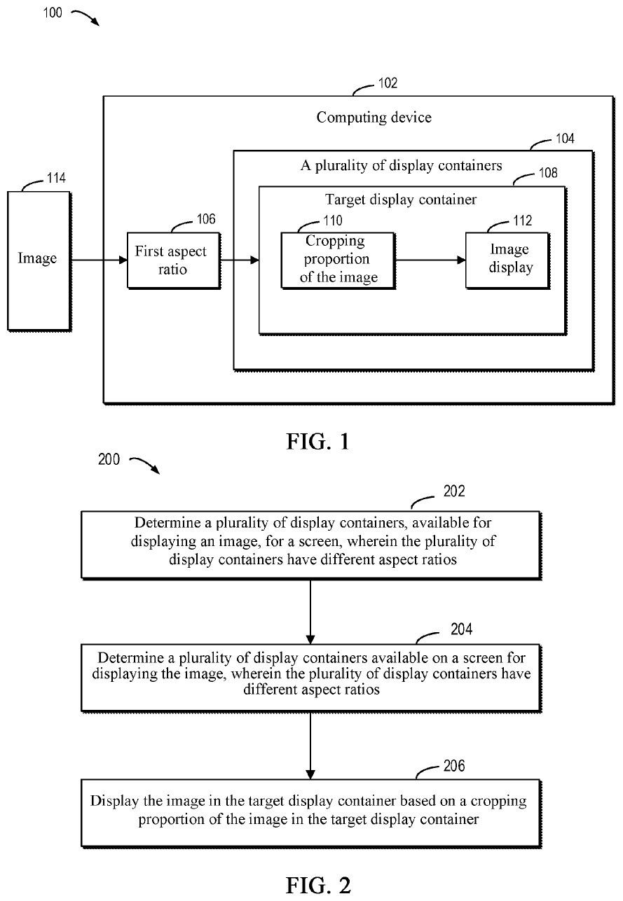

Embodiments of the present disclosure will be described in detail below with reference to the accompanying drawings. FIG. 1 illustrates an example environment in which an apparatus and/or a method according to some embodiments of the present disclosure may be implemented. In an environment 100, a computing device 102 may enable a screen to entirely display images or videos in more proportions and simplify the adaptation logic of the image or video to the screen.

Examples of the computing device 102 include, but are not limited to, personal computers, server computers, hand-held or laptop devices, mobile devices (such as mobile telephones, Personal Digital Assistants (PDAs), media players, etc.), multiprocessor systems, consumer electronics, minicomputers, mainframe computers, distributed computing environments that include any of the above systems or devices, and the like.

As shown in FIG. 1, the display screen of the computing device 102 may be generally divided into several different display areas. For example, when the computing device 102 is a mobile terminal, the display area on the screen may be divided into a top status bar area, a top operating bar area, a center display area, and a bottom search bar area or a bottom operating bar area. Typically, the center display area may act as a display container, and one or more display areas adjacent to the center display area may also be combined with the center display area to form a display container. For example, the center display area may be combined with the top status bar area of the screen to form a display container, or the center display area may be combined with the top status bar area and the bottom search bar area of the screen to form a display container. The selected plurality of display areas of the composed display container need to be continuous.

Therefore, there may be a plurality of display containers on the computing device 102. When the image or video is displayed, a plurality of display containers 104 for displaying the image or video are usually first determined. Then, the computing device 102 determines a height and a width of each display container and calculates an aspect ratio of the display container based on the height and width of each display container. The computing device 102 also orders the plurality of display containers 104 according to the aspect ratios of the display containers.

The computing device 102 may receive an image 114, e.g., an image sent from a server. Additionally, the image 114 may be a video frame of a video. The computing device 102 may determine the height and width of the image based on the information of the received image and calculate the aspect ratio of the image 114, the aspect ratio being hereinafter referred to as a first aspect ratio 106 for ease of description. Then, the computing device 102 traverses the plurality of display containers ordered according to the aspect ratios, to look for an aspect ratio of a display container closest to the first aspect ratio, and a display container finally obtained by traversing is a target display container 108 whose aspect ratio is closest to the first aspect ratio, the aspect ratio of the target display container 108 being hereinafter referred to as a second aspect ratio.

For example, when the computing device 102 receives an image sent from the sever, and the resolution of this image is assumed to be 2400*1080, the aspect ratio of the image is 0.45, i.e., the first aspect ratio is 0.45. Meanwhile, a plurality of display areas of the computing device 102 may be finally combined to form three display containers, and the aspect ratios of the display containers are calculated to be 0.45, 0.50 and 0.48, respectively. The aspect ratios of the three display containers are traversed and compared with the first aspect ratio. When it is discovered that the aspect ratio 0.45 of a display container is closest to the first aspect ratio, this display container is preferably selected as the target display container. That is, the second aspect ratio is 0.45.

In order to make the image better adapted to the display container, the computing device 102 needs to determine whether to make a cropping adaptation or a fitting adaptation to the image when the first aspect ratio of the image deviates from the second aspect ratio of the target display container. At this time, the computing device 102 will compare the first aspect ratio of the image with the second aspect ratio of the selected target display container.

When the first aspect ratio of the image is smaller than the second aspect ratio of the target display container, a proportion of a width area of the image to be cropped is calculated, and the cropping proportion may also be referred to as a first cropping proportion. After the first cropping proportion is obtained, it will be compared with a width threshold, the width threshold is a maximum allowable area loss proportion. If the first cropping proportion exceeds the width threshold, which means that the area of the image to be cropped in the width direction is larger, an effect of viewing the normal image will be affected, and loss of more image details will be caused. This situation usually occurs when a portrait-oriented device needs to display a landscape image. At this time, the computing device will cancel the cropping action and instead allow the width of the image to completely pad the target display container, and pad the top and bottom of the display container with black bars. As such, the entire image can be displayed in the display container. Although the image may be reduced to a certain degree, a better image displaying effect can be achieved, entire image information be retained and a better experience be brought to the user. If the first cropping proportion is smaller than or equal to the width threshold, which means that the cropping of a certain area of the image in the width direction does not affect the image displaying effect or exerts a small impact on the image displaying effect, the aspect ratio of the image may be adjusted by cropping a certain area of the image in the width direction to adapt to the aspect ratio of the display container.

When the first aspect ratio of the image is greater than the second aspect ratio of the target display container, the computing device 102 calculates a second cropping proportion for a height area of the image. When the second cropping proportion is greater than a height threshold, which means that the area of the image to be cropped in the height direction is larger, the effect of viewing the normal image will be affected and loss of more details will be caused, then the computing device will allow the height of the image to completely pad the target display container, and scale the image to a certain degree to allow the information of the image to be retained entirely and avoid the loss of the key parts. When the second cropping proportion is less than or equal to the height threshold, the height of the image is cropped and then the image is displayed in the display container. A ratio of the finally-obtained cropped area to the entire area of the image is the cropping proportion 110 of the image.

Finally, image display 112 is displayed in the display container according to the image obtained by the above operation. The computing device 102 outputs a height, a width, and a position parameter of the processed image.

By this method, the display container closest to the image proportion is selected, and meanwhile the interface layout is also taken into account, the basic display effect of the video is ensured, the video is not cropped excessively, excessive interference from the interface elements is not caused, and a simple adaptation strategy configuration is achieved through threshold control, the image displaying effect is effectively improved, and the user's experience is enhanced.

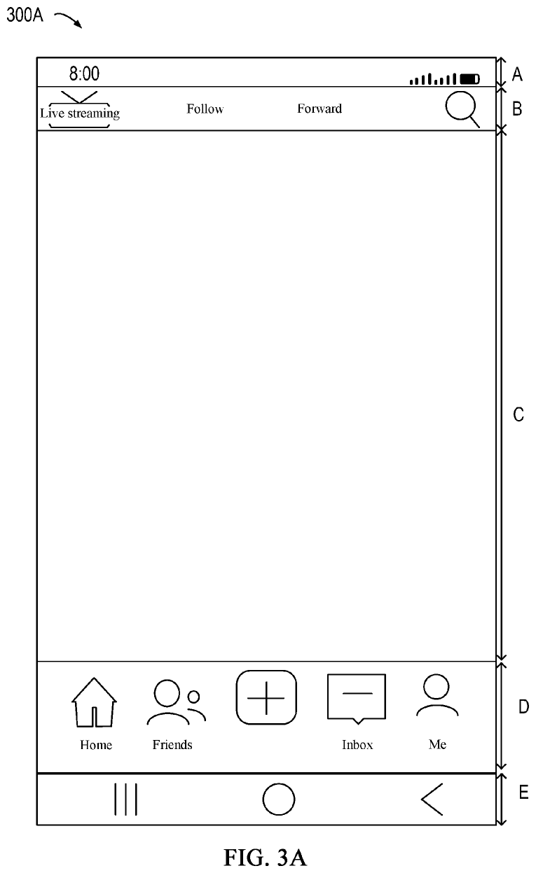

A schematic diagram of an example environment in which apparatuses and/or methods of some embodiments of the present disclosure may be implemented is described above in with reference to FIG. 1. Reference will be made below to FIG. 2 to illustrate a schematic diagram of an example method for displaying an image according to some embodiments of the present disclosure. The method in FIG. 2 may be performed by the computing device 102 of FIG. 1 or any suitable computing device.

As shown in FIG. 2, in the example method 200, at block 202, the computing device 102 determines a plurality of display containers available on a screen for displaying the image, wherein the plurality of display containers have different aspect ratios.

The plurality of display containers are formed by combining a plurality of display areas in the screen. A core of the display areas is a center display area, and other display areas may be combined with the center display area to form a larger display area which can display the image, so that the aspect ratio of the final display container is closer to the aspect ratio of the image, and the display effect of the image is better. For example, the top operation bar area plus the center display area, the top status bar area plus the top operation bar area plus the center display area. However, if the top status bar area is combined with the center display area, a display area cannot be formed because the display areas are not continuous. Meanwhile, combinations of other display areas not including the center display area are also ineffective because the display picture without the center display area is too small and the top and bottom of the picture are excessively offset. Then, the computing device 102 will work out combinations of all suitable display areas and form a plurality of display containers, and calculate the aspect ratio of each display container.

At block 204, the computing device determines a target display container from the plurality of display containers based on a first aspect ratio of the image to be displayed in the screen, wherein a difference between a second aspect ratio of the target display container and the first aspect ratio is smaller than a threshold value. When the computing device 102 receives an image 114 to be displayed on the screen from the server, the computing device first determines a height and a width of the image 114 and calculates the first aspect ratio of the image. Based on the aspect ratios of the plurality of display containers that have been calculated above, they are compared with the first aspect ratio. An aspect ratio having the smallest difference from the first aspect ratio is selected from the plurality of aspect ratios of the plurality of display containers, and the display container having the aspect ratio is determined as the closest display container whose aspect ratio is the second aspect ratio.

Finally, at block 206, the computing device 102 displays the image in the target display container based on a cropping proportion of the image in the target display container. The computing device 102 may further determine the cropping proportion of the image in the display container and then determine whether the image needs to be cropped based on the cropping proportion.

The computing device 102 will compare the first aspect ratio with the second aspect ratio to determine which suitable manner should be employed to present the image on the screen with the best effect. Therefore, the computing device compares the first aspect ratio with the second aspect ratio. If the first aspect ratio is smaller than the second aspect ratio, this indicates that the proportion of the image is wider relative to the display container, whereupon determination needs to be further made as to whether to crop the width area of the image. If the cropped area calculated at this time is smaller than or equal to the width threshold, which indicates that the cropping of a portion of the area in the width direction exerts a small impact on the whole image, the cropping may be performed. If the cropped area calculated at this time is greater than the width threshold, which indicates that a loss of an excessively large area in the width direction will probably exert an impact on the presentation of the image, a method will be employed to fill the image in the width direction, reduce the height of the image by a proportion and pad the top and bottom with black bars.

Similarly, if the first aspect ratio is greater than the second aspect ratio, which indicates that the proportion of the image is higher relative to the display container, a further determination needs to be made as to whether a height area of the image needs to be cropped. If the calculated cropping proportion is greater than a height threshold, the target display container is filled with the image in the height direction. If the cropping proportion is smaller than or equal to the height threshold, the height of the image is cropped to display the image, whereupon the loss of the cropped area in the height direction is acceptable and the loss in the display effect of the image is also small.

Next, the computing device 102 displays the image in the selected display container and meanwhile outputs a height, a width and a position parameter of the image for accurate positioning of the image and subsequent possible image cropping and scaling. When the image is displayed, if the top status bar area, the top operation bar area and the center display area are occupied by the display container at this time, various icons in the top status bar area and the top operation bar area may become transparent for the display of the image, or some icons in the two bars may be set hidden to increase the immersive experience.

By this method, the originally-needed several container proportion parameters and video proportion parameters are simplified by comparing the aspect ratio of the image with different aspect ratios of the plurality of display containers and adding the threshold value comparison, so that the strategy configuration may be achieved by controlling the threshold value, the judgment conditions are also simplified while the image displaying effect is ensured, and the user's experience is improved.

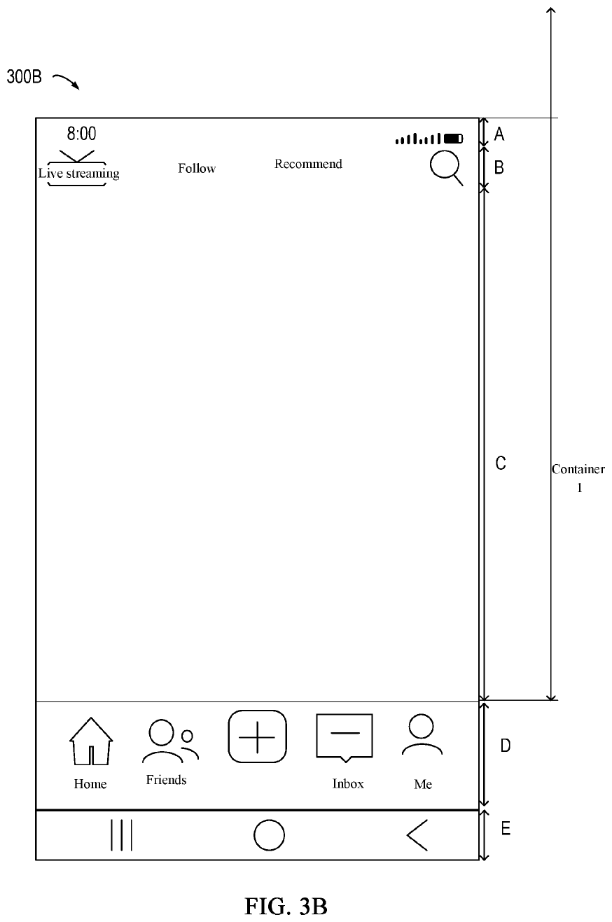

The schematic diagram of an example method for displaying an image according to some embodiments of the present disclosure is described above with reference to FIG. 2. Reference will be made below to FIG. 3A, FIG. 3B and FIG. 3C to describe an example of the division of display areas and containers in the screen, wherein FIG. 3A illustrates a schematic diagram of an example of an image display area according to some embodiments of the present disclosure.

Example 300A is a schematic illustration of a display screen displaying an image, wherein the letters on the right represent the display areas for displaying the image in this example, wherein A represents a top status bar area of the screen, which is conceptually the same as a system status bar; B represents a top operation bar area of the screen, wherein the user can perform some operations on icons in this area; C represents a center display area of the screen, and D represents a bottom operation bar area, in which the user may perform some operations on icons in this area; E represents a navigation bar area, which is same as the concept of a system navigation bar. Since area E is system-specific, it may not be used as a display container. It is meant that in this figure the four areas may all be used to form image display containers. After any display area other than the area C is used as a container, the computing device will make elements in its original display area become transparent to enable the display of the video. When A+B+C+D, the four display areas are combined as a display container, the aspect ratio at this time is the largest, and friendly for the display of some similar images with larger aspect ratios. When the aspect ratio of the displayed image needs to be reduced, the computing device may remove area A or area D and retain other areas as the display containers so that the aspect ratio will fall appropriately. If the aspect ratio of the container at this time is still larger than the displayed image, the display area combination may further be reduced. For a plurality of display containers formed by combining all available display areas, the aspect ratios of each display containers are different and therefore are friendly for the display of corresponding images having different aspect ratios.

At this time, if the display areas above the center display area are all regarded as a part of a display container, the display is through-top display at this time, and the top area may be displayed transparent at this time to display the image or video. If the display areas (except for the bottom navigation bar area) below the center display area are all regarded as a part of a display container, the display is through-bottom display at this time, and the bottom area may be displayed transparent at this time to display the image or video.

FIG. 3B and FIG. 3C further illustrate examples of the container constituted by the display area in FIG. 3A. As shown in example 300B, a container 1 includes image display areas A, B and C, such display belonging to the through-top display. For a video with a larger aspect ratio, it may be displayed on an elongate display screen in the through-top display manner or the through-bottom display manner to achieve a better display effect. As shown in example 300C, a container 2 only includes a display area C and may be used to display an image with a small aspect ratio.

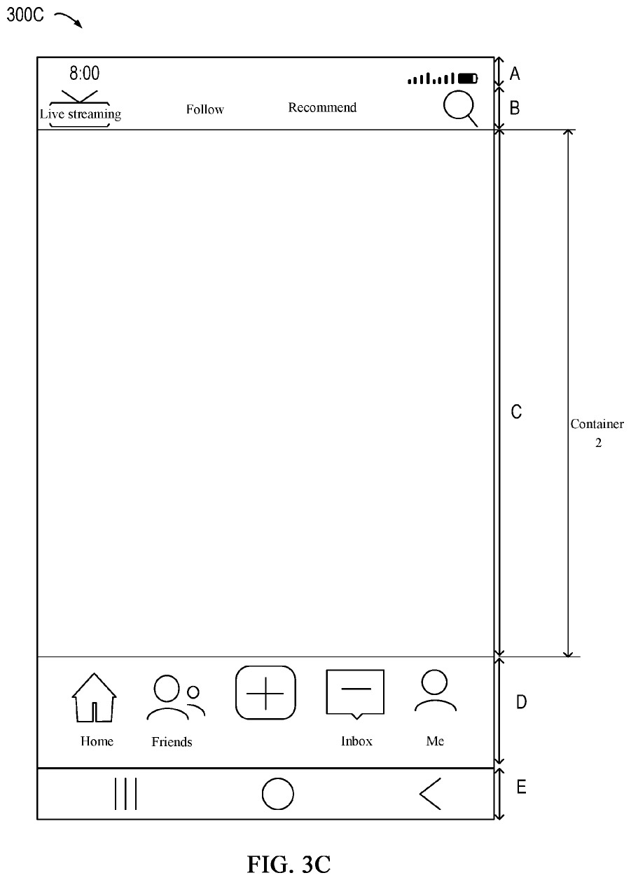

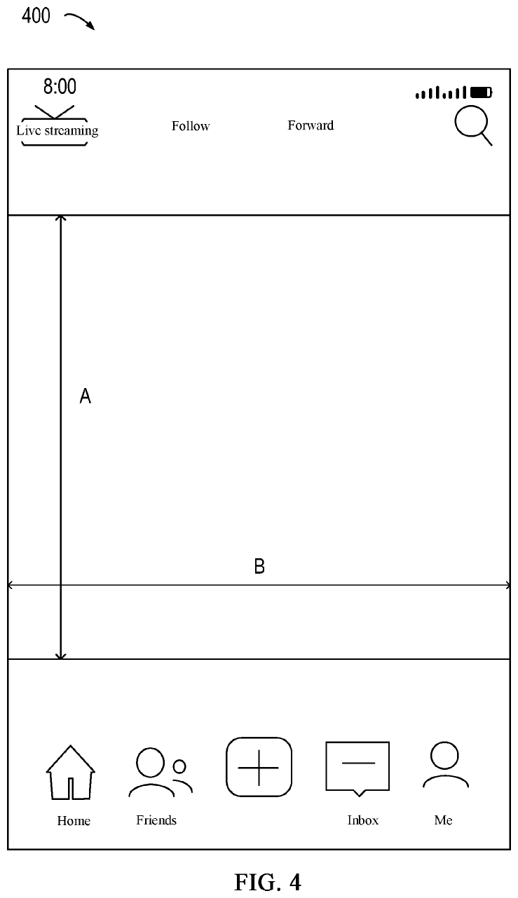

Schematic diagrams of examples of image display areas and containers according to some embodiments of the present disclosure are described above. After a suitable target display container is selected according to the aspect ratio of the container and the aspect ratio of the image, image adaptation needs to be further performed. Two cases of adaptation of the image to the target display container will be described below with reference to FIG. 4 and FIG. 5, wherein FIG. 4 illustrates an example of a fit adaption according to some embodiments of the present disclosure.

In an example method 400, in a process of displaying an image with a low aspect ratio, the image is entirely displayed in the display container, i.e., the entire image is displayed in an area with a height A and a width B in FIG. 4, whereupon other areas of the display container are padded with black bars. When the original aspect ratio of the image is the closest to the aspect ratio of the display container or when a first cropping proportion in the width direction is greater than the width threshold, the computing device may display the image using such a display strategy. Such a display strategy is favorable to restore the original image proportion without losing details of the image or losing less details of the image, and increases the user's experience in viewing the image.

FIG. 5 illustrates a schematic diagram of an example of a cropping adaptation according to some embodiments of the present disclosure. In an example method 500, after a display container is selected, the image needs to be cropped to a certain degree because the width of the image does not completely match the width of the display container. Meanwhile, the computing device 102 judges that the cropped region area does not exceed a width threshold, and the computing device will put the cropped image in the display container. As shown, the selected display container has a height C and a width B, but the image at this time has a height C and a width D, the width D of the image to be displayed is larger than the width B of the display container. In this case, the center of the image is made coincide with the center of the display container, and parts on both sides extending beyond the width are cropped until the width of the cropped image is aligned with the width of the display container. Such a display manner belongs to the cropping adaption.

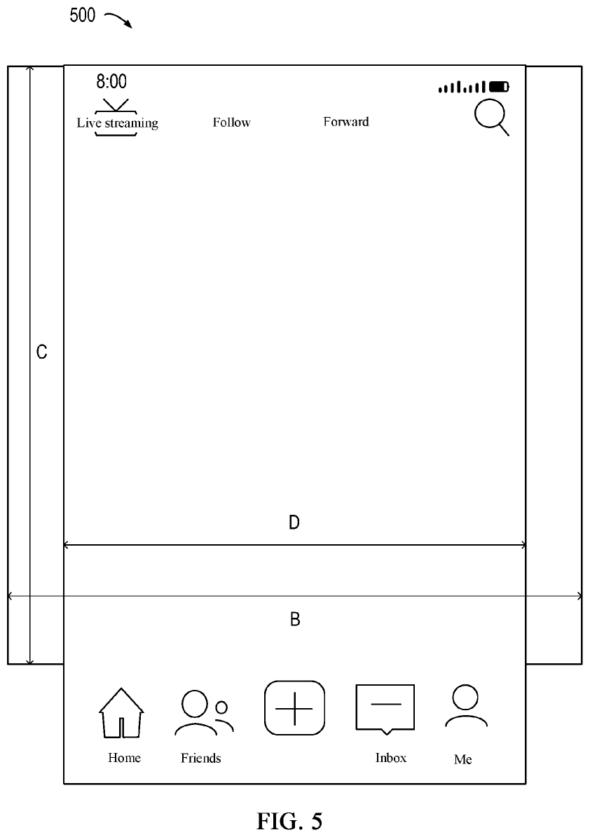

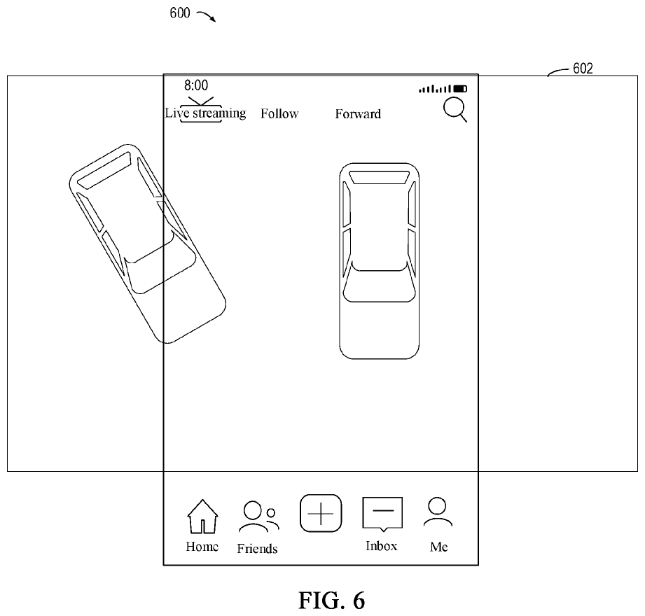

Reference will be made below to FIG. 6 and FIG. 7 to describe schematic diagrams of image display according to some embodiments of the present disclosure. In an example 600, the aspect ratio of the display container selected at this time is much greater than that of the image 602, if the computing device crops the width of the image 602, the first cropping proportion will be greater than the width threshold, whereupon a very large proportion of the image is cropped and the user's experience is poor. Therefore, the computing device will abandon the cropping scheme and turn to a scheme of padding black bars in an example 700. At this time, the computing device scales the width of the image by a proportion until the image fills the width of the whole display container, whereupon although the image is reduced, the overall image details are not lost, and meanwhile the height of the image also becomes smaller due to the proportional reduction of the width, and the computing device pads the areas except for the image display height with black bars. Such a display strategy causes the reduction of the image, but the user can see all these extremely-proportional image details more completely, with a better viewing experience.

An example of an adaption of a picture to the display screen will be described below in conjunction with an algorithm code. First, approximate proportional container adaptation is performed first. In this process, the first step is to initialize an adaptation module. At this time, top and bottom areas of the screen may be enumerated separately: for example, the top areas include a top status bar, a top operation bar, etc. from top to bottom, and the bottom areas include a bottom operation bar, a bottom search bar, etc. from bottom to top, for example as shown by the following code:

```
enum class ScreenArea(val typeName: String, private val value: Int) {
  STATUS_BAR(“status bar”, 0), // 01
  TOP_TAB(“top tab”, 1), // 11
  BOTTOM_TAB(“bottom tab”, 0), // 01
  BANNER(“banner”, 1); // 11
  companion object {
  val TOP_LIST = listOf(STATUS_BAR, TOP_TAB)
  val BOTTOM_LIST = listOf(BOTTOM_TAB, BANNER)
}
}
```

Meanwhile, the following dimensions of the areas are initialized: a screen width, a screen height, a top status bar height, a top operation bar height, a bottom search bar height, a bottom operation bar height, etc., as defined by the following code:

```
data class ScreenSettings(
//display screen parameters
  var statusBarHeight: Int = 36,
  var topTabHeight: Int = 58,
  var bottomBannerHeight: Int = 36,
  var bottomTabHeight: Int = 49,
)
```

In a second step, behavior input/output may be adapted. At this time, in addition to the input of the initialized dimensions, when the video is about to be presented, a video proportion is input and a spacing between edges of the container is output, as defined by the following code:
fun getAdaptionTypePadding(videoRatio: Float, settings: ScreenSettings):
PaddingValues

In a third step, adaptation computation may be further performed. At this time, the sizes of the containers resulting from the combinations are calculated in advance according to the initialized input. Then, a top/bottom type number is defined: a display condition of a top or bottom area is represented in a binary form of an integer; for example, if the display is the through-top display, the top two areas are both transparent, both bits of the binary number take a value 0, and the top type number is 0. Analogously, if the bottom operation bar needs to be padded with black bars, and the bottom search bar needn't be padded with black bars, the first bit takes a value 1, the second bit takes a value 0, and the bottom type number is 1. According to the area types enumerated above, all the values of the top/bottom type numbers may be further enumerated, with an enumeration algorithm being given as follows:

```
val topTypeList = getSingleTypeList(TOP_LIST.size)
val bottomTypeList = getSingleTypeList(BOTTOM_LIST.size)
//result format: [0, 1, 3, 7 ...] 000, 001, 011, 111 ...
private fun getSingleTypeList(size: Int): List<Int> {
  val list = mutableListOf<Int>( )
  for (index in 0 until size + 1) {
    list.add((1 shl index) − 1)
  }
  return list
}
```

M*N uniform types are formed by combining all top and bottom type numbers, and each uniform type corresponds to a fixed top height and a fixed bottom height, so a proportion of remaining containers may be calculated. A uniform type array generation algorithm and an algorithm for calculating a spacing between containers and a proportion of containers are presented as follows:

```
  //uniform type
    class ScreenAdaptionType (
      val topType: Int,
      val bottomType: Int,
      val topHeight: Dp,
      val bottomHeight: Dp,
      val paddingValues: PaddingValues,
      val containerRatio: Float,
    )
    //acquire a uniform type array, each uniform type including the container spacing and the container
proportion
    val typeList = mutableListOf<ScreenAdaptionType>( )
    for (topType in topTypeList) {
      val topHeight = TOP_LIST.sumHeight(topType, settings).dp
      for (bottomType in bottomTypeList) {
      val bottomHeight = BOTTOM_LIST.sumHeight(bottomType, settings).dp
      typeList.add(
          ScreenAdaptionType(
              topType, bottomType,
              topHeight, bottomHeight,
              getAreaPaddingValues(topType, bottomType, settings),
              (screenHeight − topHeight − bottomHeight) / screenWidth
            )
        )
      }
    }
    ypeList.sortBy { it.containerRatio }
    fun List<ScreenArea>.sumHeight(adaptionType: Int, settings: ScreenSettings) =
      this.map { it.getHeight(adaptionType, it.mapSettings(settings)) }.sum( )
    private fun getHeight(adaptionType: Int, height: Float): Float =
      if (getMaskedValue(adaptionType) != 0) height else 0f
```

The closest container is obtained by traversing in an ascending order according to the obtained proportion list by using the following algorithm:

```
fun getNearestAdaptionType(videoRatio: Float, settings: ScreenSettings):
  ScreenAdaptionType {
      val list = getDoubleTypeList(settings)
      for (type in list) {
        if (videoRatio > type.containerRatio) continue
        else return type //container is (closest to) higher than video
      }
    return list.last( ) // if larger than the ratio of all containers, select the final (highest) container.
```

At this time, the obtained container is a container whose proportion is the closet to the video. After the approximation proportion container adaptation, proportion threshold video adaptation may be performed. In this process, the first step is to first perform adaptation module initialization. At this time, parameter thresholds, i.e., the height threshold and the width threshold may be initialized simultaneously, as shown by the following code:
val widthThreshold: Float
val heightThreshold: Float

Then, adaptation input is defined first, and parameters include a container width and height, and a video width and height, as shown by the following code:

```
  data class VideoAdaptionParams(
    val containerWidth: Int,
    val containerHeight: Int,
    val videoWidth: Int,
    val videoHeight: Int,
    val paramsOperator: IVideoAdaptionParamsOperator? = null
) : IAdaptionParamsdeo width
```

Then, adaptation output is defined, parameters include a final video width and height, and video translation coordinates x, y, as shown by the following code:

```
data class VideoAdaptionResult(
  val width: Int,
  val height: Int,
  val translateX: Float? = null,
  val translateY: Float? = null,
  val resultOperator: IVideoAdaptionResultOperator? = null
) : IAdaptionResult {
```

Then, a judgment logic may be further executed. During the execution, a proportional relationship between the video and the container may be first checked: if the proportion of the container is larger than proportion of the video, a width area loss is calculated and compared with the width threshold. If the width loss is larger than the threshold, a strategy will be selected to adapt to the width to avoid the width loss; otherwise, a strategy will be selected to adapt to the height to accept the width loss. If the proportion of the container is not larger than that of the video, a height area loss will be calculated and compared with the height threshold. If the height loss is larger than the threshold, a strategy will be selected to adapt to the height to avoid the height loss; otherwise, a strategy will be selected to adapt to the width to accept the height loss.

val result = if (params.isContainerScaleHigher( )) {
//for a wide video, forced adaptation to the height will cause loss of width
val widthLoss = params.calWidthAreaLoss( )
if (widthLoss > widthThreshold) { //width loss should be avoided
//forcedly adapt to width, avoid width loss $widthLoss”)
params.getDimensionsByFitWidth( )
} else {
//forcedly adapt to height, accept width loss $widthLoss”)
params.getDimensionsByFitHeight( )
}
} else {
//for a narrow video, forced adaptation to the width will cause loss of height
val heightLoss = params.calHeightAreaLoss( )
if (heightLoss > heightThreshold) { //heightLoss should be avoided
// forceFit height, avoid height loss $heightLoss”)
params.getDimensionsByFitHeight( )
} else {
//forcedly adapt to the height, avoid height loss $heightLoss”)
params.getDimensionsByFitWidth( )
}
}

wherein a calculating logic for calculating a width loss value and a height loss value is:

```
private fun VideoAdaptionParams.calWidthAreaLoss( ): Double {
    return 1.0 − (videoHeight * containerWidth).toDouble( ) / (containerHeight
  * videoWidth)
  }
  private fun VideoAdaptionParams.calHeightAreaLoss( ): Double {
    return 1.0 − (containerHeight * videoWidth).toDouble( ) / (videoHeight *
  containerWidth)
  }
```

In addition, a logic for calculating the height with fixed width, and calculating the width with fixed height is:

```
private fun VideoAdaptionParams.getDimensionsByFitHeight( ):
  VideoAdaptionResult {
    val newWidth = containerHeight * videoWidth / videoHeight
    return VideoAdaptionResult(height = containerHeight, width = newWidth,
  translateY = 0f, translateX = 0f)
  }
  private fun VideoAdaptionParams.getDimensionsByFitWidth( ): VideoAdaptionResult
  {
    val newHeight = containerWidth * videoHeight / videoWidth
    return VideoAdaptionResult(height = newHeight, width = containerWidth,
  translateY = 0f, translateX = 0f)
  }
```

After the execution of above logics is completed, the final width, the final height and the translation value of the video may be obtained, and actual drawing parameters may be set according to the parameters, and the adaptation process ends up.

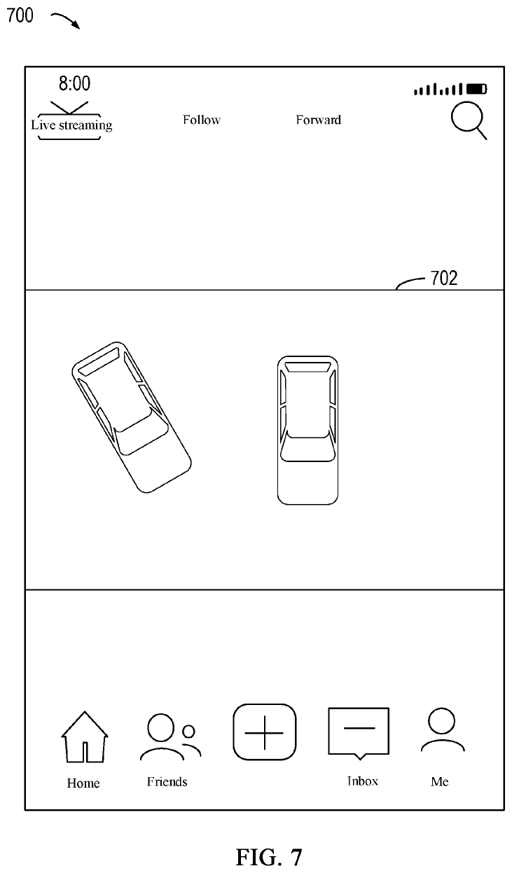

FIG. 8 illustrates a schematic block diagram of an apparatus for displaying an image according to some embodiments of the present disclosure. As shown in FIG. 8, an apparatus 800 includes a display container determination module 802, configured to determine a plurality of display containers available on a screen for displaying an image, wherein the plurality of display containers have different aspect ratios; a target container matching module 804, configured to determine a target display container from the plurality of display containers based on a first aspect ratio of the image to be displayed in the screen, wherein a difference between a second aspect ratio of the target display container and the first aspect ratio is less than a threshold value; and an image display adjusting module 806, configured to display the image in the target display container based on a cropping proportion of the image in the target display container.

In some embodiments, the display container determination module 802 includes: a display area determination module, configured to determine a plurality of display areas in the screen; and a display area selecting module, configured to determine the plurality of display containers based on the plurality of display areas.

In some embodiments, the display area selecting module includes: an adjacent display area determination module, configured to determine a group of display areas that are adjacent in the plurality of display areas; and a display container forming module, configured to form a display container of the plurality of display containers from the group of display areas.

In some embodiments, the plurality of display areas in the display container determination module 802 includes at least two areas of: a top status bar area, a top operation bar area, a center display area, a bottom search bar area, or a bottom operation bar area of the screen.

In some embodiments, the apparatus 800 further includes: an image height and width determination module, configured to determine a height and a width of the image; and a first aspect ratio calculating module, configured to calculate the first aspect ratio of the image based on the height and the width of the image.

In some embodiments, the target container matching module 804 includes: an ordering module, configured to order a plurality of aspect ratios of the plurality of display containers; a second aspect ratio determination module, configured to determine the second aspect ratio closest to the first aspect ratio by traversing the ordered plurality of aspect ratios; and a target display container determination module, configured to determine a display container having the second aspect ratio in the plurality of display containers as the target display container.

In some embodiments, the target container matching module 804 includes: a cropping proportion determination module, configured to determine the cropping proportion of the image in the target display container based on the first aspect ratio and the second aspect ratio; and a target container display module, configured to display the image in the target display container based on the cropping proportion.

In some embodiments, the cropping proportion determination module includes: an aspect ratio comparison module, configured to compare the first aspect ratio with the second aspect ratio; and a first cropping proportion calculation module, configured to calculate the first cropping proportion for a width area of the image in response to the first aspect ratio being smaller than the second aspect ratio.

In some embodiments, the target container display module includes: a width threshold comparison module, configured to determine whether the first cropping proportion is greater than a width threshold; a width threshold exceedance processing module, configured to display the image by filling the target display container with the image in a width direction in response to the first cropping proportion being greater than the width threshold; and a width threshold non-exceedance processing module, configured to display the image by cropping the width of the image in response to the first cropping proportion being smaller than or equal to the width threshold.

In some embodiments, the cropping proportion determination module further includes a second cropping proportion determination module, configured to calculate a second cropping proportion for a height area of the image in response to the first aspect ratio being greater than the second aspect ratio.

In some embodiments, the target container display module includes: a height threshold determination module, configured to determine whether the second cropping proportion is greater than a height threshold; a height threshold exceedance processing module, configured to display the image by filling the target display container with the image in a height direction in response to the second cropping proportion being greater than the height threshold; and a height threshold non-exceedance processing module, configured to display the image by cropping the height of the image in response to the second cropping proportion being smaller than or equal to the height threshold.

In some embodiments, the apparatus 800 further includes an image parameter output module, configured to output a height, a width, and a position parameter of the image.

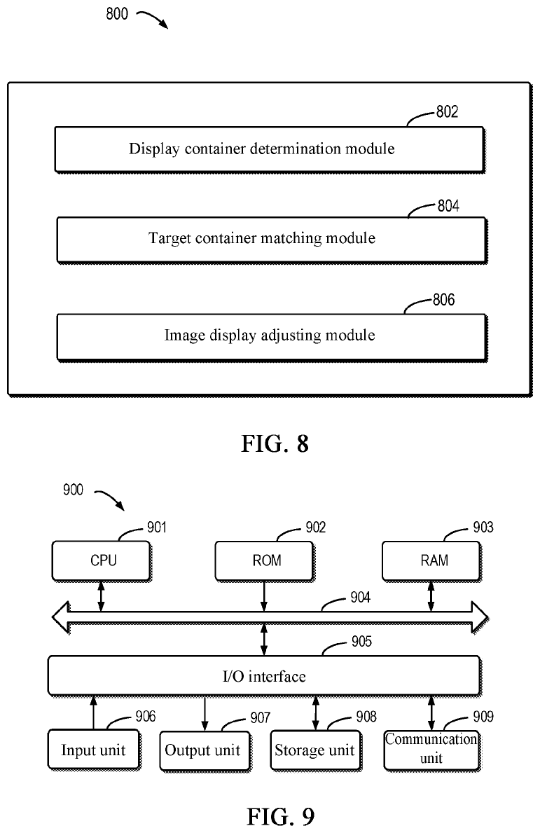

FIG. 9 illustrates a schematic block diagram of an example device 900 for implementing embodiments of the present disclosure. The computing device 102 in FIG. 1 may be implemented using the apparatus 900. As shown in FIG. 9, the device 900 includes a Central Processing Unit (CPU) 901 which may perform various suitable acts and processes in accordance with a computer program instruction stored in a Read Only Memory (ROM) 902 or a computer program instruction loaded from a storage unit 908 into a Random-Access Memory (RAM) 903. In the RAM 903, various programs and data needed by the operation of the device 900 are also stored. The CPU 901, the ROM 902, and the RAM 903 are connected to one another via a bus 904. An input/output (I/O) interface 905 is also coupled to the bus 904.

A plurality of components in the device 900 are connected to the I/O interface 905, and include: an input unit 906, such as a keyboard, a mouse, etc.; an output unit 907 such as various types of displays, speakers, and the like; a storage unit 908, such as a magnetic disk, an optical disk, etc.; and a communication unit 909 such as a network card, a modem, a wireless communication transceiver, etc. The communication unit 909 allows the device 900 to exchange information/data with other devices over a computer network such as the Internet and/or various telecommunication networks.

The various methods or processes such as method 200 described above may be performed by the processing unit 901. For example, in some embodiments, the method 200 may be implemented as a computer software program tangibly embodied on a machine-readable medium, such as storage unit 908. In some embodiments, part or all of the computer program may be loaded and/or installed on the device 900 via ROM 902 and/or communication unit 909. One or more acts in the example method 200 described above may be performed when the computer program is loaded into the RAM 903 and executed by the CPU 901.

The present disclosure may relate to methods, apparatuses, systems and/or computer program products. The computer program product may include a computer readable storage medium having computer readable program instructions embodied thereon for performing various aspects of the present disclosure.

The computer-readable storage medium may be a tangible device that can hold and store instructions for use by an instruction execution device. The computer readable storage medium may be, for example but not limited to, an electrical storage device, a magnetic storage device, an optical storage device, an electromagnetic storage device, a semiconductor storage device, or any suitable combination of the above. A non-exhaustive list of more specific examples of the computer readable storage medium includes the following: a portable computer diskette, a hard disk, a Random Access Memory (RAM), a Read-Only Memory (ROM), an Erasable Programmable Read-Only Memory (EPROM or flash memory), a Static Random Access Memory (SRAM), a portable Compact Disc Read-Only Memory (CD-ROM), a Digital Versatile Disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, etc., and conventional procedural programming languages such as “C” language or a similar programming language. The computer readable program instructions may execute entirely on the user's computer, partly on the user's computer, as a stand-alone software package, partly on the user's computer and partly on a remote computer or entirely on the remote computer or server. In the case of the remote computer, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, Field-Programmable Gate Arrays (FPGA), or Programmable Logic Arrays (PLA) may execute the computer readable program instructions by utilizing state information of the computer readable program instructions to personalize the electronic circuitry, in order to implement aspects of the present disclosure.

Aspects of the present invention are described herein with reference to flowchart illustrations and/or block diagrams of methods, apparatus (systems), and computer program products according to embodiments of the invention. It should be appreciated that each block of the flowchart illustrations and/or block diagrams, and combinations of blocks in the flowchart illustrations and/or block diagrams, may be implemented by computer readable program instructions.

These computer readable program instructions may be provided to a processing unit of a general-purpose computer, special-purpose computer, or other programmable data processing apparatus to produce a machine, such that the instructions, which executed via the processing unit of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable data processing apparatus or other device to produce a computer implemented process, such that the instructions executed on the computer, other programmable data processing apparatus, or other device implement the functions/acts specified in one or more blocks in the flowcharts and/or block diagrams.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special-purpose hardware and computer instructions.

The depictions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

I/We claim:

1. A method for displaying an image, comprising:
determining a plurality of display containers available on a screen for displaying an image, the plurality of display containers having different aspect ratios;
determining a target display container from the plurality of display containers based on a first aspect ratio of the image to be displayed in the screen, a difference between a second aspect ratio of the target display container and the first aspect ratio being less than a threshold value; and
displaying the image in the target display container based on a cropping proportion of the image in the target display container.

2. The method according to claim 1, wherein determining the plurality of display containers available on a screen for displaying the image comprises:
determining a plurality of display areas in the screen; and
determining the plurality of display containers based on the plurality of display areas.

3. The method according to claim 2, wherein determining the plurality of display containers based on the plurality of display areas comprises:
determining a group of display areas that are adjacent in the plurality of display areas; and
forming a display container of the plurality of display containers from the group of display areas.

4. The method according to claim 2, wherein the plurality of display areas comprises at least two of: a top status bar area, a top operation bar area, a center display area, a bottom search bar area, or a bottom operation bar area of the screen.

5. The method according to claim 1, further comprising:
determining a height and a width of the image; and
calculating the first aspect ratio of the image based on the height and the width of the image.

6. The method according to claim 1, wherein determining the target display container from the plurality of display containers comprises:
ordering a plurality of aspect ratios of the plurality of display containers;
determining the second aspect ratio closest to the first aspect ratio by traversing the ordered plurality of aspect ratios; and
determining a display container having the second aspect ratio in the plurality of display containers as the target display container.

7. The method according to claim 1, wherein displaying the image in the target display container comprises:
determining the cropping proportion of the image in the target display container based on the first aspect ratio and the second aspect ratio; and
displaying the image in the target display container based on the cropping proportion.

8. The method according to claim 7, wherein determining the cropping proportion of the image in the target display container comprises:
comparing the first aspect ratio with the second aspect ratio; and
calculating a first cropping proportion for a width area of the image in response to the first aspect ratio being smaller than the second aspect ratio.

9. The method according to claim 8, wherein displaying the image in the target display container based on the cropping proportion comprises:
determining whether the first cropping proportion is greater than a width threshold;
displaying the image by filing the target display container with the image in a width direction in response to the first cropping proportion being greater than the width threshold; and
displaying the image by cropping a width of the image in response to the first cropping proportion being smaller than or equal to the width threshold.

10. The method according to claim 9, wherein determining the cropping proportion of the image in the target display container further comprises:
calculating a second cropping proportion for a height area of the image in response to the first aspect ratio being greater than the second aspect ratio.

11. The method according to claim 10, wherein displaying the image in the target display container based on the cropping proportion further comprises:
determining whether the second cropping proportion is greater than a height threshold;
displaying the image by filling the target display container with the image in a height direction in response to the second cropping proportion being greater than the height threshold; and
displaying the image by cropping a height of the image in response to the second cropping proportion being smaller than or equal to the height threshold.

12. The method according to claim 1, further comprising:
outputting a height, a width, and a position parameter of the image.

13. An electronic device, comprising:
at least one processor; and
a memory, configured to store at least one program, wherein the at least one program, when executed by the at least one processor, causes the at least one processor to:
determine a plurality of display containers available on a screen for displaying an image, the plurality of display containers having different aspect ratios;
determine a target display container from the plurality of display containers based on a first aspect ratio of the image to be displayed in the screen, a difference between a second aspect ratio of the target display container and the first aspect ratio being less than a threshold value; and
display the image in the target display container based on a cropping proportion of the image in the target display container.

14. The electronic device according to claim 13, wherein the at least one program causing the at least one processor to determine the plurality of display containers available on a screen for displaying the image, further causes the at least one processor to:
determine a plurality of display areas in the screen; and
determine the plurality of display containers based on the plurality of display areas.

15. The electronic device according to claim 14, wherein the at least one program causing the at least one processor to determine the plurality of display containers based on the plurality of display areas further causes the at least one processor to:
determine a group of display areas that are adjacent in the plurality of display areas; and
form a display container of the plurality of display containers from the group of display areas.

16. The electronic device according to claim 14, wherein the plurality of display areas comprises at least two of: a top status bar area, a top operation bar area, a center display area, a bottom search bar area, or a bottom operation bar area of the screen.

17. The electronic device according to claim 13, wherein the at least one program further causes the at least one processor to:
determine a height and a width of the image; and
calculate the first aspect ratio of the image based on the height and the width of the image.

18. The electronic device according to claim 13, wherein the at least one program causing the at least one processor to determine the target display container from the plurality of display containers further causes the at least one processor to:
order a plurality of aspect ratios of the plurality of display containers;
determine the second aspect ratio closest to the first aspect ratio by traversing the ordered plurality of aspect ratios; and
determine a display container having the second aspect ratio in the plurality of display containers as the target display container.

19. The electronic device according to claim 13, wherein the at least one program causing the at least one processor to display the image in the target display container further causes the at least one processor to:
determine the cropping proportion of the image in the target display container based on the first aspect ratio and the second aspect ratio; and
determine the display of the image in the target display container based on the cropping proportion.

20. A non-transitory computer readable storage medium storing a computer program thereon, wherein the computer program, when executed by a processor, causes the processor to:
determine a plurality of display containers available on a screen for displaying an image, the plurality of display containers having different aspect ratios;
determine a target display container from the plurality of display containers based on a first aspect ratio of the image to be displayed in the screen, a difference between a second aspect ratio of the target display container and the first aspect ratio being less than a threshold value; and
display the image in the target display container based on a cropping proportion of the image in the target display container.
